(19) United States
(12) Patent Application Publication
(10) Pub. No.: US 2012/0018065 A1
(43) Pub. Date: Jan. 26, 2012

(54) TEXTILE WEB MATERIAL AND METHOD FOR PRODUCING THE SAME

(75) Inventor: Jörge Ruschulte, Rickenbach (DE)

(73) Assignee: GLOBAL SAFETY TEXTILES GMBH, Maulburg (DE)

(21) Appl. No.: 13/262,365

(22) PCT Filed: Feb. 8, 2010
(86) PCT No.: PCT/EP2010/000770

§ 371 Date: Sep. 30, 2011

(30) Foreign Application Priority Data
Apr. 2, 2009 (DE) 10 2009 016 041.8

(51) Int. Cl. B60C 27/00; D03D 41/00; B32B 3/00; D03D 11/02

(52) U.S. Cl. 152/208; 139/11; 428/156

(57) ABSTRACT

A woven textile web material having an upper fabric layer (O) and a lower fabric layer (U), comprising warp threads (K) and first and second weft threads, and including carrier filaments (FF) and enwinding filaments (UF) encompassing the same as second weft threads. The carrier filaments (FF) are integrated in the textile web material such that they appear at the surface of the upper fabric layer (O) in first width areas (I) substantially parallel to the warp thread direction, and do not appear at the surface of the upper fabric layer (O) in second width areas (II) substantially parallel to the warp thread direction (O).

The present invention relates to a woven textile web material having an upper fabric layer and a lower fabric layer comprising carrier filaments and entwining filaments encompassing said carrier filaments, the invention also relating to a method for producing same.

Known from German Patent Application 10 2007 036 855 A1 (RUD) is a vehicular anti-skid device in the form of a textile snow chain comprising a tread belt covering the full width of the ice/outer side of the snow chain facing away from the tire tread with a plurality of stiff monofilaments as carrier filaments entwined preferably with steel wire (to form entwining filaments) for better traction of the vehicle when negotiating ice and snow. The drawback of this snow chain is that it quickly wears out when partially negotiating ice and snow in combination with a dry road surface. Indeed, after just low mileage over dry roads the carrier filaments can become disrupted over the full width due to warp thread portions becoming detached from the tread, resulting in the entwining filaments (preferably made of steel) eating at the warp threads carrying them, causing the latter to droop loose over the width of the tread from which they subsequently become fully detached ruining proper functioning as a snow chain.

The present invention is based on the object of proposing a textile web material which avoids, or at least greatly diminishes, the drawbacks known from prior art, as well as proposing a method for producing same.

This object is firstly achieved by a textile web material as set forth in claim 1 featuring an upper fabric layer and a lower fabric layer, comprising warp threads and first and second weft threads, and comprising carrier filaments and entwining filaments encompassing said carrier filaments as second weft threads, characterized in that the carrier filaments are integrated in the textile web material such that they appear at the surface of the upper fabric layer in first width portions substantially parallel to the warp thread direction, and do not appear at the surface of the upper fabric layer in second width portions substantially parallel to the warp thread direction.

Engineering a textile web material in accordance with the invention now makes it possible to advantageously lengthen the lifetime of the snow chain as compared to that of prior art. Now, carrier filaments become detached substantially later and then just in the region of the first width portions. The resulting lesser load on the carrier filaments enhances the treatment of the warp threads integrating the carrier filaments longitudinally, in again adding to the lifetime.

In one advantageous aspect of the invention the textile web material is characterized in that it comprises a right-hand casing and a left-hand casing with a tread inbetween, the casings featuring third width portions in which the carrier filaments are integrated in the textile web material such that they do not appear at the surface of the upper fabric layer and the tread comprises first and second width portions.

The particular advantage of this configuration is that the textile web material now represents practically the complete snow chain. The casings arranged in the borders can immediately double as the means sealingly locating the casing of the tire, whereby the carrier filaments likewise “concealed” in the region of the borders are held captive there and are thus already “purged”.

In another advantageous aspect of the invention the textile web material is characterized in that the tread comprises in the weft thread direction a specially selected distribution of first width portions also differing in width sited transversely over the width of the tread. This now makes it possible to advantage to select and locate the first width portions adapted as wanted to a profile structuring and shape of a tire in thus reducing the wear and tear on both the tire and on the snow chain. In this arrangement in accordance with the invention of the carrier filaments they are made to protrude inwards, i.e. directed at the tread in the grooves thereof which is particular kind on the warp threads integrating the carrier filaments because of this geometry, this again adding to the lifetime decisively.

In still another advantageous aspect of the invention the textile web material is characterized in that it is woven in a predefined length and that the tread features length portions oriented substantially parallel to the weft thread direction in which no second weft threads are integrated, this now making it possible to produce the snow chain already established in length on the weaving machine. These woven textile web material pieces already established in length are termed panels. Usually the ends are e.g. stitched with patches featuring pairs of Velcro fasteners. When the edge of a patch is arranged in a length portion of the textile web material in a snow chain encompassing a tire, in which no second weft threads are integrated, then the edge can be “submerged” so-to-speak.

In yet a further advantageous aspect of the invention the textile web material is characterized in that the second weft threads comprise entwining filaments in an S or Z-type entwinement, depending on which is selected it can now be attained to advantage which effectively influences the tracking of the textile web material or of a snow chain as engineered in accordance with the invention.

In yet a further advantageous aspect of the invention the textile web material is characterized in that a second weft thread with an S-type entwinement regularly alternates with a Z-type entwinement, it having namely surprisingly been discovered that such a regular alternation in which a second weft thread with an S-type entwinement regularly alternates with a Z-type entwinement, preferably results in a particularly stable tracking of a wheel equipped with a snow chain in accordance with the invention whilst additionally promoting a stable location of the snow chain on the wheel.

The object of the invention is further achieved by a method as it reads from claim 9, namely a method of producing a woven textile web material having an upper fabric layer and a lower fabric layer, comprising warp threads and first and second weft threads, and comprising carrier filaments and entwining filaments encompassing said carrier filaments as second weft threads, characterized in that the carrier filaments are integrated in the textile web material such that they appear at the surface of the upper fabric layer in first width portions I substantially parallel to the warp thread direction, and do not appear at the surface of the upper fabric layer in second width portions substantially parallel to the warp thread direction.

This method in accordance with the invention now makes it possible to advantage to cost-effectively produce a textile web material, resulting in a very hard-wearing fabric for use in textile snow chains with no particular extra complications.

One advantageous aspect of the method in accordance with the invention for producing a textile web material as it reads from claim 2, 3, 4, 5, 6 or 7 is characterized in that the textile web material is woven in a multiple, juxtaposed arrangement in a web with the obvious advantage that the textile web material can now be produced multiply in a single operation.

In one advantageous aspect of the method in accordance with the invention the textile web materials woven multiply juxtaposed in a web in the warp thread direction are parted from each other by means of a thermomechanical, ultrasound or laser welding process. For example, the polymer fractions of the carrier filaments are parted by means of a hot wire and the steel fractions of the entwining filaments by means of a mechanical parting device. This achieves by relatively simple means textile web materials neatly separated from each other, having edges no longer in need of any finishing.

Cutting the individual panels to length is preferably done by means of laser welding in the weft thread direction in accordance with the correspondingly woven single lengths.

In a further embodiment of the method in accordance with the invention the textile web material is correspondingly woven in the weft thread direction multi-webbed and in the warp thread direction in the predefined length sequence including the length portions in which no second weft threads (FF) are included.

In another further embodiment of the method in accordance with the invention the textile web material woven in predefined length sequence is panelled in the weft thread direction by means of a mechanical, thermal or laser parting device.

Further features and advantages of the invention read from the sub-claims.

For a better understanding of the invention and to illustrate how it can be cut out, the invention will now be briefly described by way of example embodiments with reference to the drawing in which

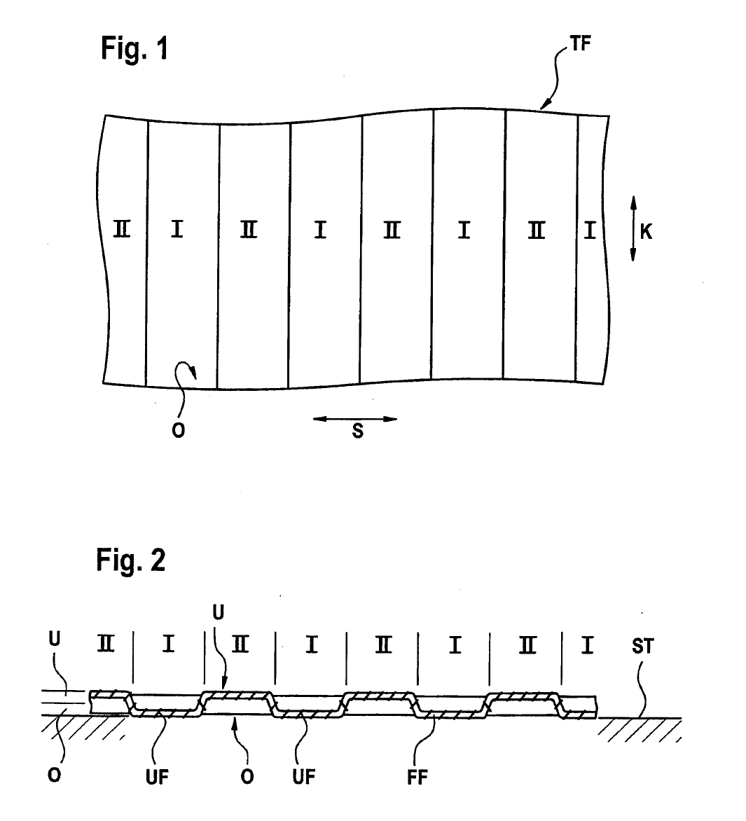

FIG. 1 is a diagrammatic top-down view of the textile web material in accordance with the invention.

FIG. 1a is a further diagrammatic top-down view of the textile web material in accordance with the invention in another example.

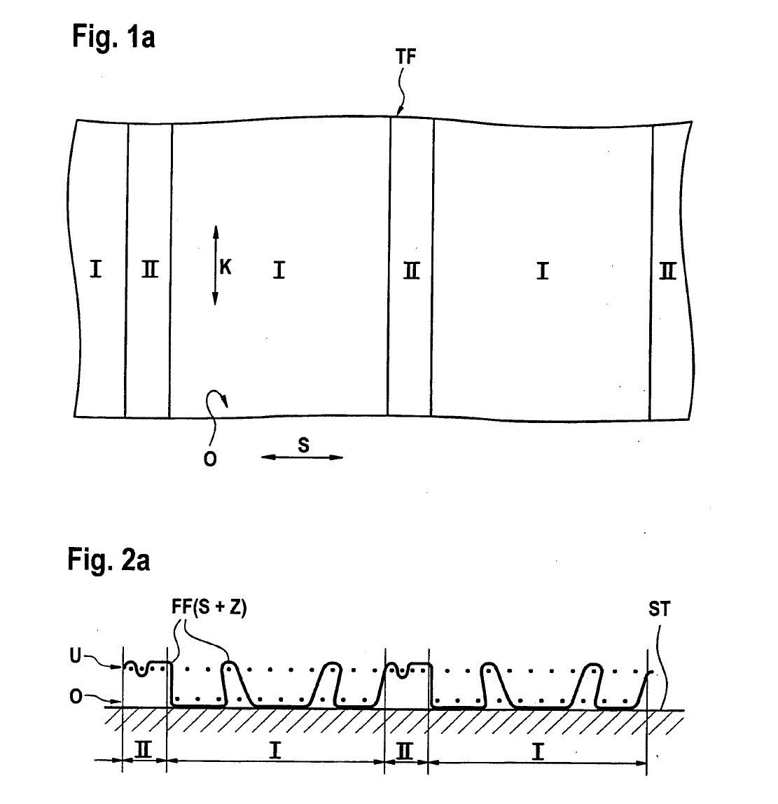

FIG. 2 is a diagrammatic cross-sectional view of the textile web material in accordance with the invention as shown in FIG. 1.

FIG. 2a is a diagrammatic cross-sectional view of the textile web material in accordance with the invention as shown in FIG. 1a similar to that as shown in FIG. 2 but explicitly indicating warp threads and weft threads.

FIG. 2b is a diagrammatic cross-sectional view of a prior art textile web material.

FIG. 2c is a diagrammatic cross-sectional view of the textile web material in accordance with the invention as shown in FIG. 1a similar to that as shown in FIG. 2a, but in another variant.

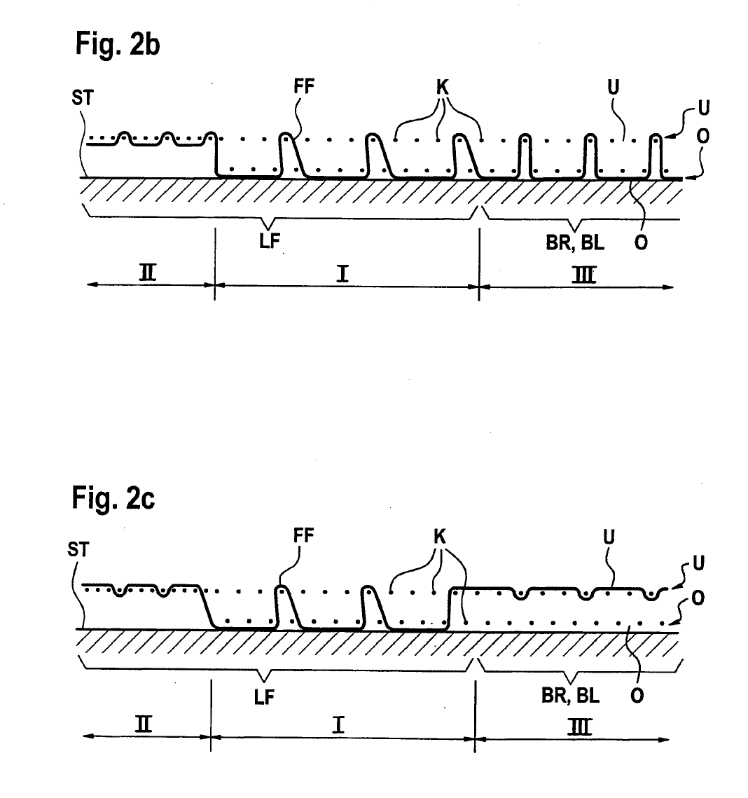

FIG. 3 is a diagrammatic top-down view of a further embodiment of the textile web material in accordance with the invention.

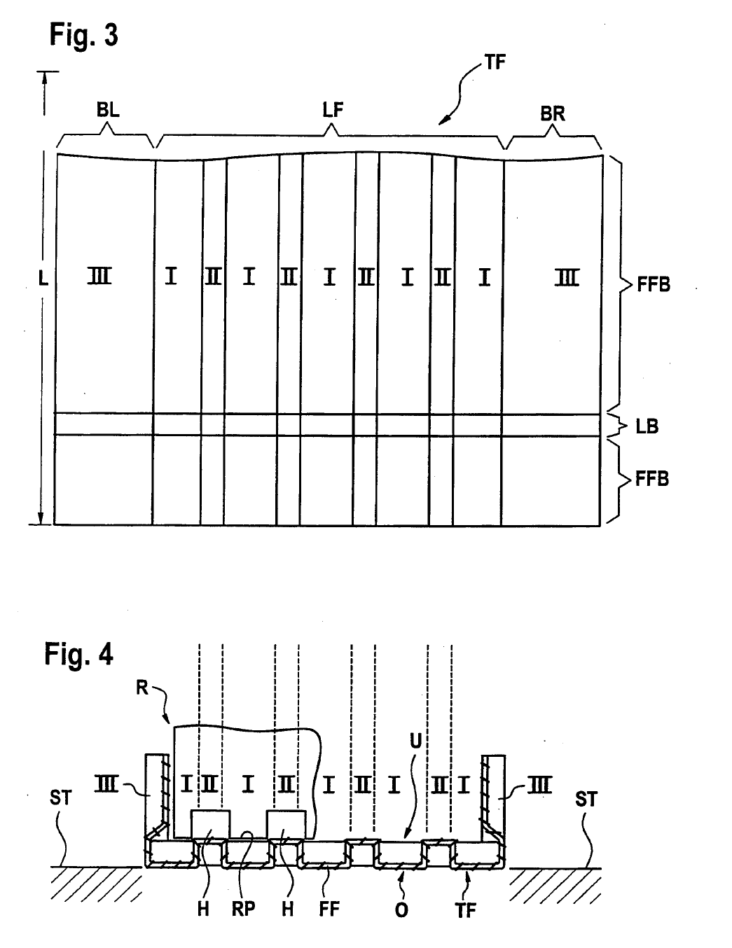

FIG. 4 is a diagrammatic cross-sectional view of a further embodiment of the textile web material in accordance with the invention.

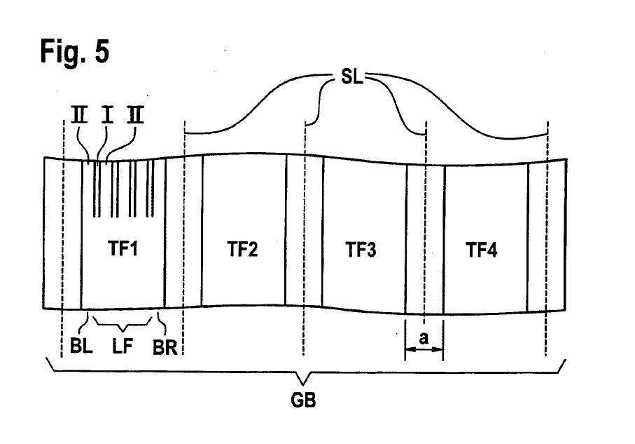

FIG. 5 is a diagrammatic illustration of a portion of a fully woven web GB.

Referring now to FIG. 1 there is illustrated a top-down view of part of a textile web material TF in accordance with the invention as an example depicted very simply diagrammatically, indicating for example the upper fabric layer O with the alternating width portions I and II, wherein the two-way arrow S indicates the weft thread direction and the two-way arrow K the warp thread direction.

Referring now to FIG. 2 there is illustrated a diagrammatic cross-sectional view of the textile web material in accordance with the invention as shown in FIG. 1. Pointing to the bottom edge of the sheet is the upper fabric layer O whilst the lower fabric layer U points in the opposite direction. In the width portions I pointing in the direction of the road surface ST indicated diagrammatically carrier filaments FF enter the upper fabric layer O but in the width portions II they do not enter the upper fabric layer O. The entwining filaments UF entwining the carrier filaments FF engage the road surface ST. In the width portions II the carrier filaments FF are “submerged” in the textile web material TF having no contact with the road surface ST resulting in this portion being exposed to no wear and tear.

Referring now to FIG. 1a there is illustrated a diagrammatic top-down view of the textile web material TF in accordance with the invention in another example, showing here how narrow width portions II and much wider width portions I have been selected.

Referring now to FIG. 2a there is illustrated how in the proportions taken over from FIG. 1a the warp threads are indicated by heavy dots for easy recognition, wrapped by a carrier filaments FF shown only once by way of example. In the width portions II the carrier filament FF runs in the lower fabric layer U, and in the width portion I the carrier filament FF runs substantially in the upper fabric layer O, it thereby floating over two or three warp threads of the upper fabric layer O whilst being integrated in each case by only one warp thread of the lower fabric layer U.

Referring now to FIG. 2b there is illustrated a diagrammatic cross-sectional view of a prior art textile web material. In both the first width portion I with a first type of weave representing the tread LF when used as a snow chain, and in the second width portion II with a weave much tighter than said first type of weave as well as in the third width portion III the carrier filaments FF point substantially to the upper fabric layer O in thus being exposed to contact with the road surface ST. Although this does not apply to the third width portion III, the casing portion BR, BL, to the same degree as to the two other portions I and II. This illustrates, however, the main drawback of this prior art achievement, namely how this design is exposed to damage with a low resistance to wear and tear.

Referring now to FIG. 2c there is illustrated a diagrammatic cross-sectional view of the textile web material in accordance with the invention as shown in FIG. 1a similar to that as shown in FIG. 2a, but in another variant, especially for comparison to prior art as shown in FIG. 2b, clearly indicating the immense advantage afforded by the design in accordance with the invention. In the width portion II the carrier filament FF runs away from the upper fabric layer O and in the lower fabric layer U additionally also at the side pointing away from the road surface ST in thus being optimally protected from wear and tear. Now, as compared to prior art the lay of the carrier filaments FF in the web material in the zones exposed to wear and tear is practically inverted. Also provided in the width portion II is a much tighter weave than in width portion I. Preferably the cover factor attains a WALZ density of approx. 100% in portion I, approx. 130% in portion II and approx. 110% in portion III, the carrier filaments FF being covered in the portion I in the lower fabric layer U up to approx. 66%, in the portion II—featuring only a lower fabric layer U—up to approx. 130% and in portion III up to approx. 78%. The width portion II with a coverage totalling less than 10% to advantage in a snow chain in accordance with the invention attains a cover factor better than 90% WALZ density even as high as 130% for the carrier filaments FF in this advantageous example embodiment.

In the double-layer width portion III as shown in the example embodiment of FIG. 2c presenting the casing BR, BL of a snow chain in accordance with the invention, the cover factor density for the carrier filaments FF in the lower fabric layer U is higher than that of the lower fabric layer U in width portion I. At the same time the covering thread sequence with 2/1 is greatly shortened as compared to the remaining width portions I and II comprising a covering thread sequence of 3/1. Both the cover factor and the thread sequence result to advantage in a particular reliable anchorage of the carrier filaments in the casing, in other words, in the width portion III. The upper fabric layer O of the casing or width portion III makes for the cover promoting resistance to wear and tear with no integration of the carrier filaments FF.

Referring now to FIG. 3 there is illustrated a diagrammatic top-down view of part of a further embodiment of the textile web material in accordance with the invention woven adapted in a predefined length L. Clearly evident are the casings BL and BR, also termed third width portions III, in which the carrier filaments FF are integrated in the textile web material so that they do not appear at the surface at upper fabric layer O. Disposed between the casings BR and BL is the tread LF of the textile web material TF. Woven into length portions FFB are carrier filaments FF, unlike the length portion LB shown by way of example in which no carrier filaments FF are woven. These portions having no carrier filaments FF have a favourable effect when the textile web material is employed as a snow chain by making it difficult for snow to become packed, clogging up the snow chain.

Referring now to FIG. 4 there is illustrated how, as described above, carrier filaments FF arranged in width portion I protruding from the upper fabric layer O in the direction of the road surface are entwined by entwining filaments UF, whereas the carrier filaments FF in the width portions II are “submerged” in the depth of the textile web material. A portion of a tire R indicated diagrammatically has a tread with cleats RP adjoining the lower fabric layer U. Cavities H disposed between the cleats RP of the tire are arranged to agree with the width portions II of the textile web material TF. When employed as a snow chain this has the advantage that the carrier filaments FF entwined by the entwining filaments UF are urged into contact with the road surface only in the width portions I. The width portions II of the snow chain are subjected only to minor wear and tear because they are not urged into contact with the road surface. It is understood that the road surface ST is intended to represent various conditions in the sense of that described such as when dry, iced over or covered in snow.

Referring now to FIG. 5 there is illustrated a portion of a web GB fully woven on a weaving machine (not shown) with, for example, four panels TF1 to TF4 configured analogous to the textile web material TF as shown in FIGS. 1 to 4 and comprising width portions I and II as well as borders BL and BR which may be cut out of the web GB in accordance with the invention along the broken lines SL. Note that the spacings a can be selected as wide or narrow as required.

The width portions I, II and III have in sum a cover factor DG of better than 90% WALZ density. The tread LF is formed by the width portions I having highest traction and the width portions II running parallel thereto.

In the lower fabric layer U of the width portion I the carrier filaments FF are woven in with a cover factor DG of better than 60% WALZ density.

In the width portions II preferably covering less than 30% of the total (tread) surface the carrier filaments FF are woven in with a cover factor DG of better than 90% WALZ density.

The width portions III or casings comprise an upper fabric layer O and a lower fabric layer U. In the lower fabric layer U the carrier filaments FF are woven in with a cover factor DG of better than 70% WALZ density.

The lifetime of a snow chain engineered with the textile web material in accordance with the invention is increased to advantage by preventing the carrier filaments FF from becoming detached by additionally anchoring them in the width portions II configured in accordance with the invention as can be achieved, on the one hand, by interlacing the carrier filaments FF at the underside of the width portions II and, on the other hand, dimensioning the cover factor WALZ density in the width portions II substantially higher by way of a single layer covering structure than is the case in the lower fabric layer U of the width portions I and III. In this arrangement the carrier filaments are integrated in the textile web material such that they appear at the surface of the upper fabric layer O in first width portions I substantially parallel to the warp thread direction, and do not appear at the surface of the upper fabric layer O in second width portions II substantially parallel to the warp thread direction.

1. A woven textile web material having an upper fabric layer and a lower fabric layer, comprising warp threads and first and second weft threads, and comprising carrier filaments and entwining filaments encompassing said carrier filaments as second weft threads, wherein said carrier filaments are integrated in the textile web material such that they appear at the surface of the upper fabric layer in first width portions substantially parallel to the warp thread direction, and do not appear at the surface of the upper fabric layer in second width portions substantially parallel to the warp thread direction.

2. The textile web material as set forth in claim 1, wherein it comprises a right-hand and left-hand casing with a tread inbetween, said casings featuring third width portions in which the carrier filaments are integrated in the textile web material such that they do not appear at the surface of the upper fabric layer and the tread comprises first and second width portions.

3. The textile web material as set forth in claim 1, wherein said tread LF comprises first width portions evenly distributed in the weft threads as so-called borders.

4. The textile web material as set forth in claim 1, wherein said tread comprises in the weft thread direction a specially selected distribution of first width portions also differing in width sited transversely over the width of the tread.

5. The textile web material as set forth in claim 1, wherein it is woven in a predefined length and that the tread features length portions oriented substantially parallel to the weft thread direction in which no second weft threads are incorporated.

6. The textile web material as set forth in claim 1, wherein said second weft threads comprise entwining filaments in an S or Z-type entwinement.

7. The textile web material as set forth in claim 1, wherein a second weft thread with an S-type entwinement filament regularly alternates with a second weft thread with Z-type entwinement filament.

8. A textile snow chain featuring a textile web material as set forth in claim 1.

9. A method of producing a woven textile web material having an upper fabric layer and a lower fabric layer, comprising warp threads and first and second weft threads, and comprising carrier filaments and entwining filaments encompassing said carrier filaments as second weft threads, wherein said carrier filaments are integrated in the textile web material such that they appear at the surface of the upper fabric layer in first width portions substantially parallel to the warp thread direction, and do not appear at the surface of the upper fabric layer in second width portions substantially parallel to the warp thread direction.

10. A method of producing a woven textile web material as set forth claim 2, wherein said textile web material is woven in a multiple, juxtaposed arrangement in a web.

11. The method as set forth in claim 10, wherein said textile web materials woven multiply juxtaposed in a web in the warp thread direction are parted from each other by means of a thermomechanical, ultrasound or laser welding process.

12. The method as set forth in claim 10, wherein said textile web material is correspondingly woven in the weft thread direction multi-webbed and in the warp thread direction in the predefined length sequence including the length portions in which no two weft threads are included.

13. The method as set forth in claim 12, wherein said textile web material woven in predefined length sequence is panelled in the weft thread direction by means of a mechanical, thermal or laser parting device.
